(19) United States
(12) Patent Application Publication
(10) Pub. No.: US 2021/0174384 A1
(43) Pub. Date: Jun. 10, 2021

(54) DYNAMIC GIFT CARD SYSTEM

(71) Applicants: Jeffrey SKEEN, Encinitas, CA (US); Eric Campbell, Del Mar, CA (US); Gina M. Paolino, San Diego, CA (US)

(72) Inventors: Jeffrey SKEEN, Encinitas, CA (US); Eric Campbell, Del Mar, CA (US); Gina M. Paolino, San Diego, CA (US)

(21) Appl. No.: 17/112,524

(22) Filed: Dec. 4, 2020

Related U.S. Application Data
(60) Provisional application No. 62/944,249, filed on Dec. 5, 2019.

(51) Int. Cl. G06Q 30/02; G06Q 20/34

(52) U.S. Cl. CPC G06Q 30/0215; G06Q 30/0235; G06Q 20/342

(57) ABSTRACT

Dynamic system for gift cards or certificates allowing business partners to create dynamic incentives for products/services and allow only segments of purchasers to purchase and redeem a gift card at participating business locations. Dynamic system allows for business partners to authorize the number of gift cards to be sold, products and services eligible for additional incentives at the time gift card is redeemed, to identify eligibility of purchasers, geographic locations where gift card can be redeemed and duration of incentive offers which provides significant specificity and segmentation of incentive offers to business partners. Dynamic gift card system can be utilized to direct gift card purchasers or registered holders to various websites or physical business locations to redeem gift cards and their associated incentive offers. Dynamic gift card system allows business partners to dynamically alter products and services that can be purchased with gift card as well as incentive offers.

### CLAIM OF PRIORITY

This patent application claims the benefit of priority to U.S. Provisional Application Ser. No. 62/944,249, filed Dec. 5, 2019, which is incorporated by reference herein in its entirety.

### BACKGROUND

A purchaser prepays the face value of a gift card, electronic certificate or electronic voucher (collectively, a “Gift Card”) which can later be used as an alternative payment method in addition to cash, check, bank transfer, electronic payment, loan or credit card to complete a variety of purchases. The Gift Card can be used as a prepaid debit card in the case of a physical Gift Card or electronic payment in the case of an electronic certificate or voucher that contains a specific amount of money available for use. The user of the Gift Card can be the purchaser of the Gift Card or an individual to whom the purchaser has gifted or transferred the Gift Card. Certain gift cards and electronic certificates can be associated with a specific retail business such that the Gift Card can be redeemed at the retail business' brick-and-mortar retail store(s) or its website(s). In order to increase the value of the Gift Card, certain businesses could elect to provide one or more incentives that increase the redemption value of the Gift Card above the initial purchase price or face value that can be disclosed to potential buyers prior to their purchase of a Gift Card or to purchasers following their purchase. These additional business incentives can be accessed by the dynamic system which will update the system in real time and can thereafter notify the registered Gift Card user of the additional incentives. After a Gift Card is partially or fully redeemed at an associated business or retailer, the business or retailer associated with the Gift Card can drive other promotions or offers as part of post purchase surveys or to provide information on other promotions and offers available.

### BRIEF DESCRIPTION OF THE DRAWINGS

In the drawings, which are not drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a block diagram illustrating an example of the dynamic Gift Card and electronic certificate system according to one embodiment.

FIG. 2 is block diagram illustrating further details regarding the Gift Card and electronic certificate server system, according to exemplary embodiments.

FIG. 3 is a schematic diagram illustrating data which may be stored in the database of the dynamic Gift Card and electronic certificate server system, according to various exemplary embodiments.

FIG. 4 is an exemplary flow diagram of a process to activate a Gift Card according to one embodiment.

FIG. 5 is an exemplary flow diagram of a process to make dynamic changes to the gift cards and/or electronic certificates according to one embodiment.

FIG. 6 is a block diagram illustrating a representative software architecture, which may be used in conjunction with various hardware architectures herein described.

FIG. 7 is a block diagram illustrating components of a machine, according to some exemplary embodiments, able to read instructions from a machine-readable medium (e.g., a machine-readable storage medium) and perform any one or more of the methodologies discussed herein.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Among other things, embodiments of the present disclosure improve the functionality of the Gift Card and electronic certificate systems by enhancing the authentication process prior to activating the Gift Card and by preparing the Gift Card purchaser or registered holder for the redemption process. The dynamic system provides a platform which allows for the Gift Card business partner (e.g., businesses redeeming the gift card) to drive purchases by dynamically altering the purchased Gift Card's value via various incentives. The system can include a website or call center service for activating the Gift Card and for viewing various incentives offered by the associated business or its partners. The system can be utilized to direct purchasers or registered holders of the Gift Card to various websites or business locations to redeem the Gift Card. The system can also use post Gift Card redemption surveys to verify customer satisfaction that can be shared with the Gift Card merchant and the Gift Card business partner.

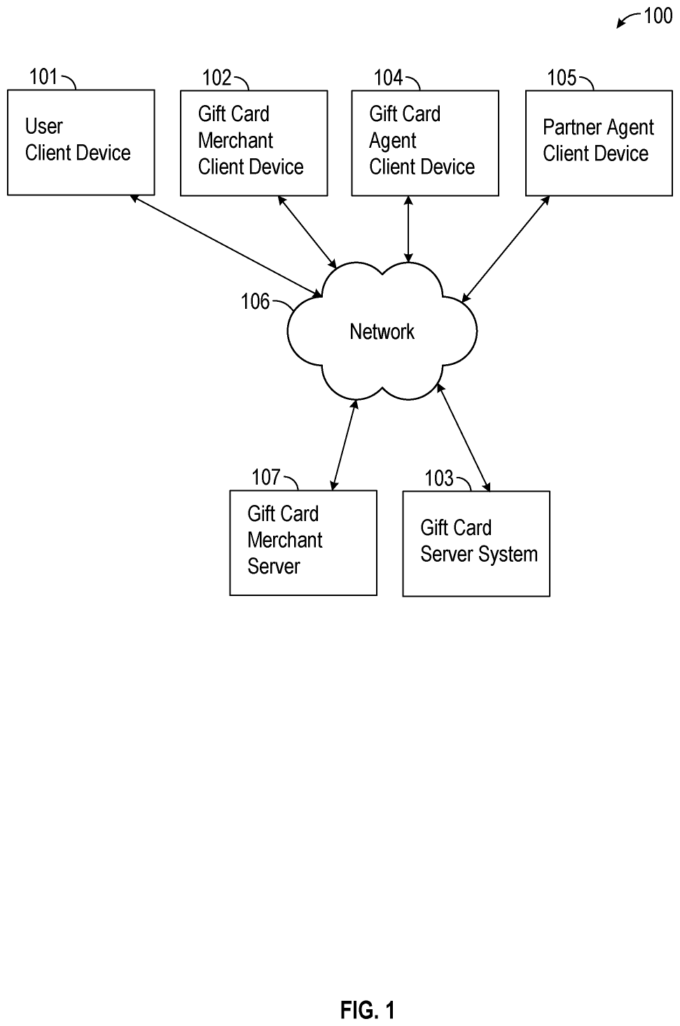

FIG. 1 is a block diagram illustrating an example of a Gift Card and electronic certificate system 100 according to one embodiment. The Gift Card and electronic certificate system 100 includes at least one user client device 101, at least one Gift Card merchant client device 102, at least one Gift Card agent client device 104, at least one partner agent client device 105, and a Gift Card merchant server 107 that are each communicatively coupled to a Gift Card server system 103 via a network 106.

As used herein, the term “client device” may refer to any machine that interfaces to a communications network (such as network 106) to obtain resources from one or more server systems or other client devices. A client device may be, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access a network.

In one embodiment, the user client device 101 is the device associated with a user who purchased a Gift Card. A person can purchase a Gift Card from a merchant's brick-and-mortar location or website (“Gift Card Merchant”). In one embodiment, the Gift Card Merchant is a retail store or warehouse business (e.g., Costco Wholesale). The Gift Card Merchant is associated with the Gift Card Merchant client device 102 and a Gift Card Merchant server 107.

When a user purchases a Gift Card from the Gift Card Merchant's brick-and-mortar location, the Gift Card can include a physical Gift Card including an item number that is unique to the Gift Card (e.g., Gift Card number), the offer details, the activation process details, the redemption information, as well as the rest of the Gift Card terms and conditions. In some embodiments, the Gift Card offer can detail that a user purchases the Gift Card for a prepaid amount (i.e., $100) that includes certain incentives that could be worth more than the prepaid amount (i.e., $300) when redeemed according to the terms and conditions as set forth by a Gift Card business partner (i.e., a business or businesses associated with the Gift Card offer) such as an automotive original equipment manufacturer (“OEM”) (e.g., Toyota or Ford) (“Gift Card Business Partner”). Prior to redeeming the Gift Card, the Gift Card purchaser or an authorized recipient needs to activate the Gift Card by visiting the Gift Card Merchant's or its vendor's website to register the authorized user who is the only user eligible to redeem the Gift Card (“Registered Holder”). At the time of Gift Card activation, the Gift Card merchant or their agent issues a unique authorization number and PIN associated with the registered Gift Card to the Registered Holder. In one embodiment, the Gift Card cannot be redeemed by anyone other than the Registered Holder.

At the time of Gift Card activation, in one embodiment, the Gift Card merchant or their agent determines whether the Gift Card purchaser is eligible to purchase the Gift Card. For example, eligibility requirements can be set by the Gift Card business partner, Gift Card Merchant or by the Gift Card server system 103. For example, one requirement can be that the Gift Card purchaser be a member with the Gift Card Merchant for a minimum duration of time (e.g., Member since 2015). Other examples of requirements include requirements based on geographic location (e.g., purchaser has to be within a zip code or state, purchaser has to be outside of specific zip codes or states, etc.), age, sex, demographic, etc. In one embodiment, the Gift Card

In one embodiment, the Gift Card purchaser is the only person who can obtain a refund for the cost of the Gift Card (e.g., prepaid amount of $100) from the Gift Card Merchant. In another embodiment, the Gift Card purchaser and the authorized recipient can obtain a refund for the cost of the Gift Card (e.g., prepaid amount of $100) from the Gift Card Merchant. In one embodiment, the prepaid amount of the Gift Card is a deposit in a trust account that is maintained by the Gift Card server system 103 for the Gift Card Business Partner. When obtaining a refund, the Gift Card purchaser or the authorized recipient can obtain a refund from the trust account maintained by the Gift Card server system 103.

At time of redemption, the Registered Holder of the Gift Card must present the Gift Card along with its authorization number and PIN to the Business Partner. In one embodiment, an OEM employee uses the Gift Card merchant client device 102 accesses the Gift Card merchant server 107 and provides the Gift Card number, Registered Holder's name, unique authorization number and PIN to the Gift Card merchant server 107. The Registered Holder's authorization number can also be associated with the Gift Card purchaser's membership number or identification information that identifies the Gift Card holder within the Gift Card merchant server 107 (e.g., Costco member number). In some embodiments, the Gift Card purchaser provides their own or another user's information that is associated with the Gift Card (e.g., a Gift Card recipient's identification number) which the Business Partner can provide to the Gift Card merchant server 107 at time of redemption. In one embodiment, while the Business Partner is associated with the Gift Card (e.g., Volvo), the Gift Cards can be redeemable at a store (e.g., a Volvo Dealership). In this embodiment, the store (e.g., Volvo Dealership) is providing to the Gift Card merchant server 107 or to the Gift Card server system 103 the user's information that is associated with the Gift Card (e.g., a Gift Card recipient's identification number) at time of redemption.

At the time of redemption, via the Gift Card server system 103, the Gift Card merchant server 107 or the Business Partner (using the Business Partner Client Device) can also perform a verification of the person redeeming the Gift Card. For example, the Gift Card server system 103 can receive an inquiry from either the Gift Card Merchant Server 107 or the Business Partner Client Device 105 regarding whether the person attempting to redeem the Gift Card is a Gift Card Purchaser or a Gift Card recipient (e.g., Registered Holder). In one embodiment, the inquiry can also include the eligibility requirements set by the Gift Card business partner, Gift Card Merchant or by the Gift Card server system 103. For example, the eligibility requirements that were imposed on the Gift Card Purchaser can also be applied to the Gift Card recipient in order to redeem the Gift Card. In some embodiments, if the Gift Card recipient fails to meet the eligibility requirements, the Gift Card recipient may not be eligible to receive additional promotions but may be eligible for a base promotion. In this example, the Gift card may have been purchased for a prepaid amount of $100 and redeemable for $200. A Gift Card business partner could have added a time limited promotion (e.g., Labor Day weekend) that allows the Gift Cards to be redeemed for $500. The Gift Card recipient who fails to meet an eligibility requirement (e.g., Los Angeles residents only) can only redeem the Gift Card for $200, but not for $500 over Labor Day weekend.

In one embodiment, Gift Card server system 103 can also perform further validations to prevent the Gift Cards to be purchased in bulk. By purchasing the Gift Cards in bulk, a purchaser (e.g., Manufacturers, user purchasers, dealerships, etc.) could gain a competitive advantage over other manufacturers or dealers. In this example, the Gift Card server system 103 performs further validations by limiting the number of Gift Cards that can be purchased by a single person or entity. In another example, the Gift Card server system 103 performs further validations by limiting the number of Gift Cards that can be purchased by a limited number of people (e.g., two people) associated with the same entity (e.g., Manufacturer or Dealership).

In another embodiment, a purchaser utilizing their client device 101 can access the Gift Card merchant server 107 via the Gift Card merchant's website (e.g., www.costco.com). The purchaser selects an electronic Gift Card (e-card) or e-voucher for purchase via the merchant's website. The electronic Gift Card can include or be associated with an item number that is unique to the Gift Card offer (e.g., e-card number), photos and videos of the item, item details, electronic delivery details, the Business Partner incentive offer details, the activation process details, the redemption process details, refund details as well as all of the other Gift Card terms and conditions. During the purchase process, the Gift Card merchant server 107 via the Gift Card merchant's website can request and receive from the user client device 101 information including the purchasing user's identification number (e.g., user's membership number), shipping address, email address, phone number, etc. The Gift Card merchant server 107 can also request and receive another user's identification number to be associated with the electronic Gift Card (e.g., a Gift Card recipient's identification).

In one embodiment, the Gift Card merchant server 107 can transmit information to the Gift Card server system 103 including, for example, the purchaser's name, address, membership number or customer number if any, phone number, email address, item number, e-card number, website indicator, etc.

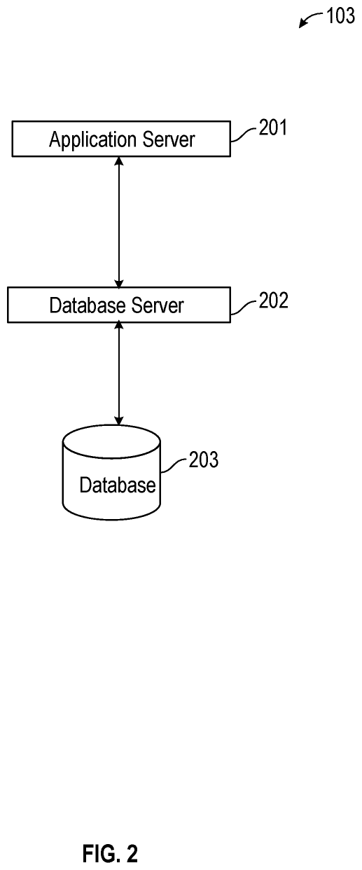

Referring to FIG. 2, a block diagram illustrating further details regarding a Gift Card server system 103, according to exemplary embodiments, is shown. The Gift Card server system 103 includes an application server 201 that is communicatively coupled to a database server 202, which facilitates access to a database 203 in which stored data is processed by the application server 201.

The Gift Card server system 103, via the application server 201, can process and store the information from the Gift Card merchant server 107 in the database 203 included in the Gift Card server system 103. The Gift Card server system 103 can transmit the electronic Gift Card (e.g., e-card, or e-voucher) to the purchasing user's client device 101. In another embodiment, the Gift Card server system 103 can transmit the electronic Gift Card to the Gift Card recipient's client device 101. The electronic Gift Card can be transmitted in an electronic message (e.g., email or text message) with instructions on how to activate and redeem the Gift Card.

In one embodiment, an employee of the Gift Card merchant or their service vendor (e.g., customer service department) can activate the Gift Card for the purchasing user or Gift Card recipient by providing the purchasing user's information (e.g., a membership number, name, phone number, driver's license, etc.) and the Gift Card number to a Gift Card agent client device 104 or to the Gift Card server system 103. The user using the user client device 101 can also directly activate the Gift Card by providing information to the Gift Card agent client device 104. The Gift Card agent client device 104 can be associated with a human agent or an automated agent. The user can communicate with the human agent or the automated agent via a telephone call or via electronic messages (e.g., electronic chat, email correspondences, SMS text messages). In this embodiment, the Gift Card agent client device 104 transmits the purchaser's information and the Gift Card number to the Gift Card server system 103 for verification and activation. Further discussion on this process is discussed below.

Once activated, the Gift Card server system 103 transmits to Registered Holder's client device 101 an electronic communication (e.g., email or text message) with information such as the authorization number, the personal identification number (PIN), Business Partner information for redemption of the Gift Card (e.g., dealership or merchant locations that could redeem the Gift Card), instructions on how to redeem the Gift Card, terms and conditions, etc.

The Business Partner agent client device 105 is associated with a Business Partner which can be a business that will redeem the gift card. For example, the Business Partner can be an automobile manufacturer, restaurant or retailer. In one embodiment, the Purchaser buys the Gift Card for a prepaid amount (e.g., $100) with its additional incentive redemption value above the prepaid amount (e.g., $200) when redeemed at the Business Partner in compliance with its terms and conditions. The Business Partner via the Business Partner agent client device 105 can communicate with the Gift Card server system 103 a change in the incentive value that the Business Partner is willing to provide to the Registered Holder at the time the Gift Card is redeemed for certain products or services. The Business Partner can make changes to the available incentive benefit for certain or all existing Gift Cards or for a segment of its available products or services available for sale (e.g., all outstanding gift cards for a particular make of OEM vehicle such as all 2020 model year Toyota Land Cruisers, or parts and services for all OEM vehicles). The Business Partner can increase the redemption value of the Gift Card (e.g., $150 to $300) for a certain promotional period of time or the remaining duration of the Gift Card. In this example, the promotional redemption value is greater than the initial redemption value for a certain promotional period of time or the remaining duration of the Gift Card. Accordingly, while the purchaser bought the Gift Card for an expected redemption value equal to $150 ($100 purchase price plus an additional $50 incentive from the Business Partner, the Business Partner can dynamically increase the redemption value of the card from $150 to $200 by increasing the incentive amount from $50 to $100. The Business Partner can also decrease the redemption value from the promotional redemption value back to purchase price if the Registered Holder doesn't meet all of the advertised terms and conditions of the Gift Card. The Business Partner agent client device 105 can transmit to the Gift Card server system 103 the change information including the change in the incentive redemption value, the length of time associated with the change in incentive redemption value, and the terms and conditions of the incentive redemption products or services or duration of the Gift Card incentive (e.g., make and model of car, the year of the car, participating locations for redemption, etc.).

Upon receiving the change information from the Business Partner agent client device 105, the Gift Card server system 103 processes the change information, and updates the database 203, determines the Gift Cards that are affected by the change and transmits a notification to the purchaser or Registered Holder client devices 101 that are associated with the affected Gift Cards and/or the Gift Card merchant server 107 and Gift Card merchant client device 102. The notification can include the details of the change. The notification can be a push notification, an email, or text message.

The Gift Card server system 103 can also determine when the incentive redemption value expires. In response to determining that the incentive redemption period has expired, the Gift Card server system 103 can update the database 203 by changing the incentive redemption value associated with the Gift Cards back to the initial purchase price. In one example, the promotional redemption value is replaced with the initial redemption value. In some embodiments, the Gift Card server system 103 can cause a notification to be displayed by the purchaser's or Registered Holder's client device 101, the Gift Card merchant server 107, Gift Card merchant client device 102 and/or any combination thereof to indicate the expiration of the incentive redemption period.

In another embodiment, prior to the expiration of the incentive redemption period, the notification to be displayed by the purchaser's or the Registered Holder's client device 101 can be caused to be displayed which includes a reminder to the purchaser or the Registered Holder to redeem the Gift Card and to take advantage of the incentive redemption value.

While not shown, the purchaser or Registered Holder's client device 101, the Gift Card merchant client device 102, the Gift Card agent client device 104, and the Business Partner agent client device 105 can include a Gift Card client application that is able to communicate and exchange data with another Gift Card client application and with the Gift Card server system 103 via the network 106. The data exchanged between Gift Card client applications, and between a Gift Card client application and the Gift Card server system 103, includes functions (e.g., commands to invoke functions) as well as payload data (e.g., text, audio, video or other multimedia data).

The network 106 may include, or operate in conjunction with, an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including third generation wireless (3G) networks, fourth generation wireless (4G) networks, fifth generation wireless (5G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

In one embodiment, the Gift Card server system 103 provides server-side functionality via the network 106 to a particular Gift Card client application. The Gift Card server system 103 supports various services and operations that are provided to the Gift Card client application. Such operations include transmitting data to, receiving data from, and processing data generated by the Gift Card client application. Data exchanges within the messaging system 100 are invoked and controlled through functions available via user interfaces (UIs) of the client devices.

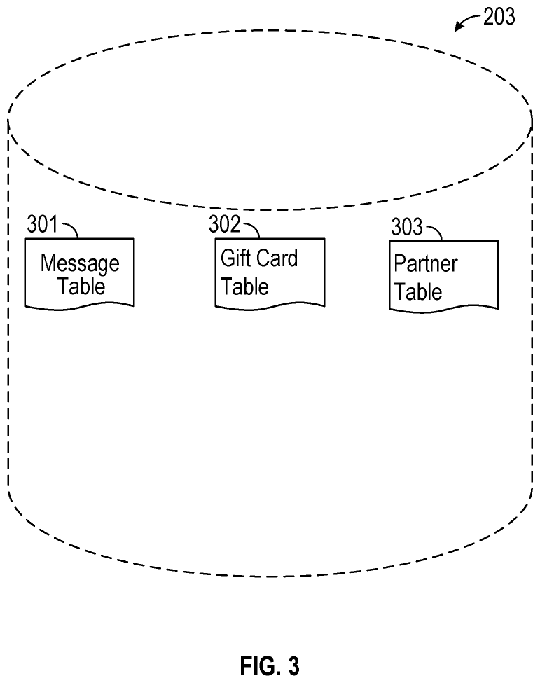

FIG. 3 is a schematic diagram illustrating data which may be stored in the database 203 of the Gift Card server system 103, according to certain exemplary embodiments. While the content of the database 203 is shown to comprise a number of tables, it will be appreciated that the data could be stored in other types of data structures (e.g., as an object-oriented database).

The database 203 includes message data stored within a message table 301. The message data can include messages received from the user client device 101, the Gift Card merchant client device 102, the Gift Card agent client device, 104 and the Business Partner agent client device 105.

The database 203 includes Gift Card data stored within a Gift Card table 302. The Gift Card data can include for each Gift Card entry, for example, a Gift Card number or a digital electronic certificate (e-certificate) number, a Gift Card value, a membership or customer number of the Gift Card purchaser, a first and last name of the member that purchased the gift card, a first and last name of the individual receiving the gift card, an authorization number, a Personal Identification Number (PIN), the incentive redemption offer, the Business Partner products and services associated with the Gift Card, etc. In one embodiment, the product associated with the Gift Card can be a vehicle such that the Gift Card data further includes the year, make, and model of the vehicle eligible for the incentive redemption offer at time of redemption.

The database 203 includes Business Partner data stored within a Business Partner table 303. The Business Partner data includes, for example, a list of the Business Partners that are associated with the Gift Card system 100. The Business Partners can include the businesses that are redeeming the gift cards. In one embodiment, the partners are vehicle dealerships that are redeeming the gift cards with the purchase of one of their vehicles that are for sale. The vehicle dealerships can include dealerships for different makes of automobiles (e.g., Toyota, Honda, etc.).

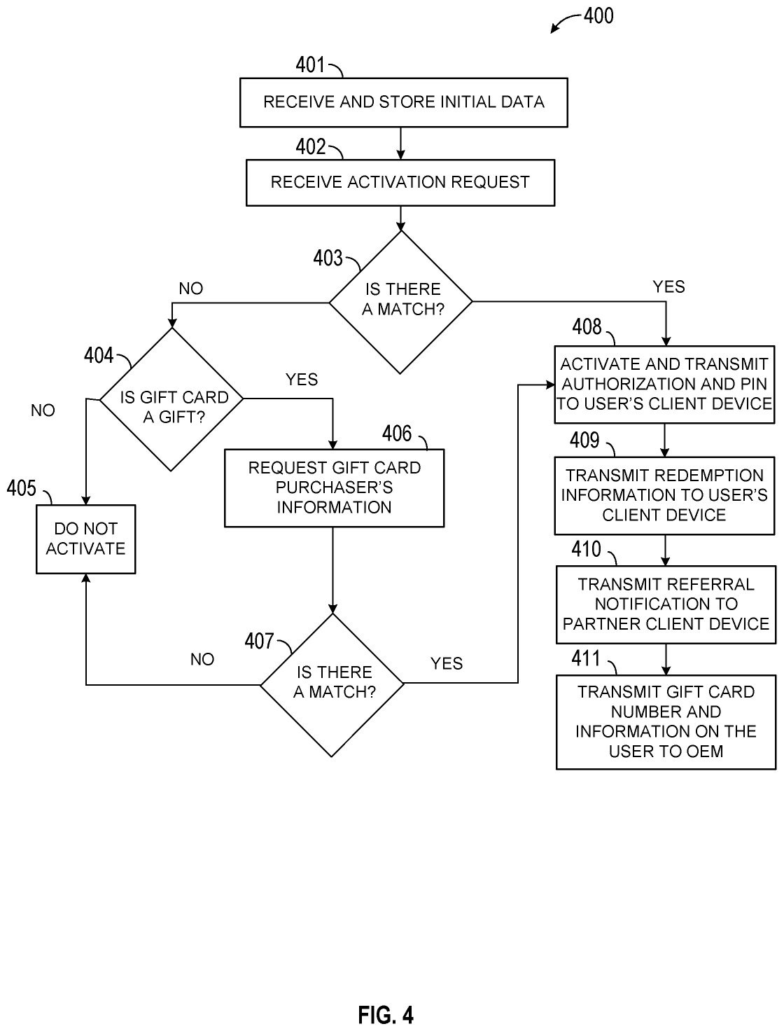

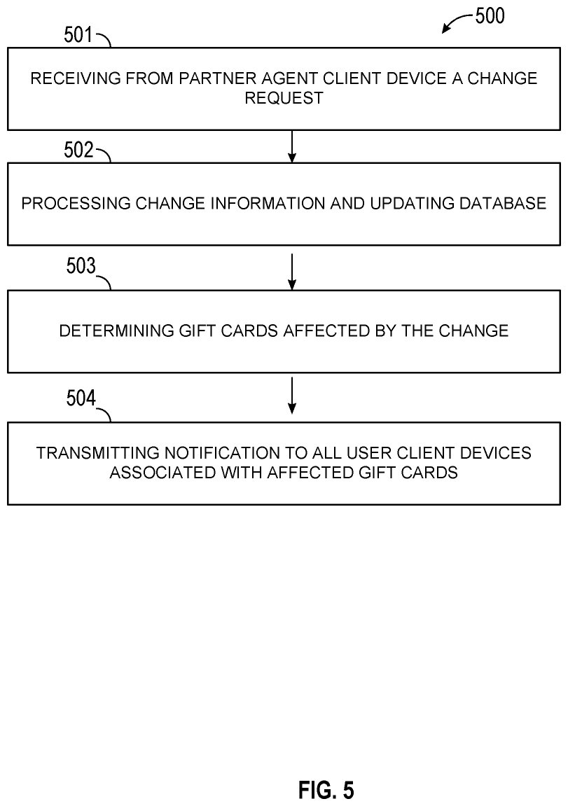

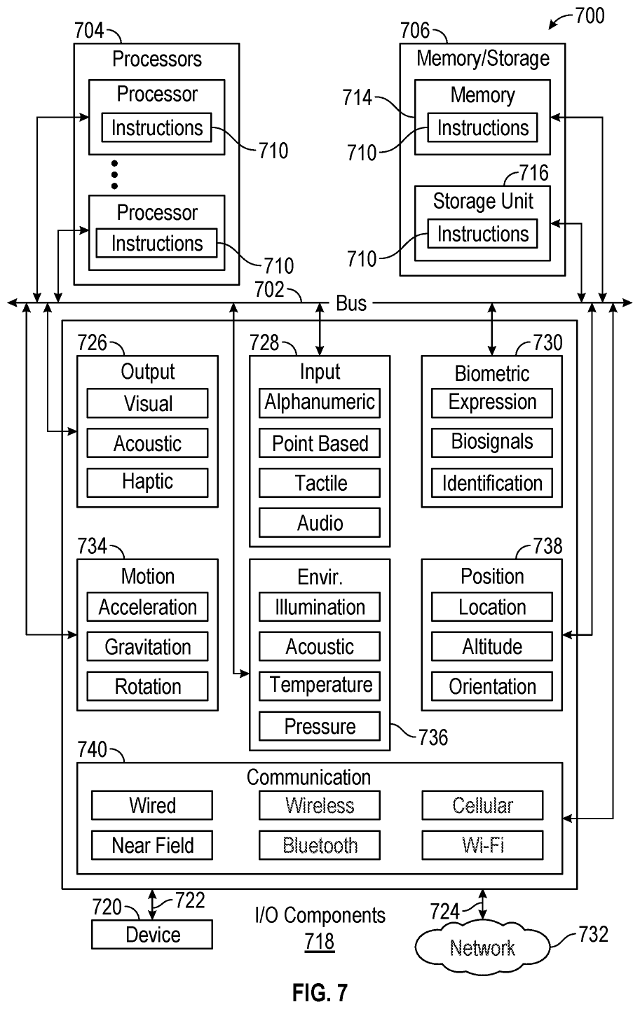

FIGS. 4-5 are exemplary flow diagrams of processes according to various aspects of the disclosure. Although the flowcharts may describe the operations as a sequential process, many of the operations can be performed in parallel or concurrently. In addition, the order of the operations may be re-arranged. A process is terminated when its operations are completed. A process may correspond to a method, a procedure, etc. The steps of methods may be performed in whole or in part, may be performed in conjunction with some or all of the steps in other methods, and may be performed by any number of different systems, such as the systems described in FIG. 1 and/or FIG. 7.

FIG. 4 is an exemplary flow diagram of a process 400 to activate a Gift Card according to one embodiment. While the process 400 is described as being performed by the Gift Card server system 103, it is understood that the process can also be performed by, in part, or entirely by the Gift Card agent client device 104.

Process 400 starts, at operation 401, the processor of application server 201 in the Gift Card server system 103 receives and stores initial data from the Gift Card merchant server 107. In some embodiments, the initial data is received from the user client device 101 or the Gift Card merchant client device 102. The initial data can include the user's membership number, the first and last name, mailing address, phone number, and email address. The user can be the user who purchased the gift card. In one embodiment, the initial data can also include information on a Gift Card recipient. The initial data can also include the Gift Card number, the item number, the date of sale, the original equipment manufacturer (OEM), the Gift Card value (e.g., redemption value), initial prepaid amount, etc. In one embodiment, the Gift Card can be associated with more than one OEM. For example, the Gift Card can be purchased for an initial prepaid amount (e.g., $1,000) and is redeemable for a redemption value (e.g., $1,500) from more than one OEM (e.g., Toyota and Honda). In this embodiment, the initial data can include the plurality of OEMs (e.g., Toyota and Honda) that are available to redeem the Gift Card.

At operation 402, the processor receives a request to activate the Gift Card from a purchaser or Registered Holder client device 101. The request to activate includes purchaser information which may also include a membership number and a Gift Card number. In one embodiment, the Gift Card Merchant and the purchaser are not associated via a membership. In this embodiment, instead of the purchasing user membership number, the purchasing user's information (e.g., name, phone number, driver's license, identification number, etc.) can be used.

At operation 403, the processor determines whether the Gift Card number and the membership number match the purchasing user membership number and the Gift Card number stored in the database 203.

When the processor determines that there is no match, the processor at operation 404 determines whether the Gift Card is a gift (e.g. or associated with a Gift Card recipient). In one embodiment, the processor generates and causes to be displayed on the purchaser's client device 101 a query regarding whether the Gift Card is a gift (e.g., “Did you receive this Gift Card as a gift?”). The processor can then receive a yes or no response from the user client device 101.

When the processor determines that the Gift Card is not a gift and that there isn't a match between the purchaser and the requestor's information, the processor does not activate the Gift Card (operation 405). The processor can cause to a message to be displayed on the display of the requestor's client device 101 that the Gift Card cannot be activated because the requestor's information does not match the purchaser's information.

When the processor determines that the Gift Card is a gift, at operation 406, the processor requests the Gift Card purchaser's information from the requestor's client device 101. For example, the processor can cause the request for the Gift Card purchaser's information to be displayed on the requestor's client device 101. The Gift Card purchaser's information can include the first and last name of the Gift Card purchaser and may include the Gift Card purchaser's membership number if applicable.

At operation 407, the processor then determines whether the Gift Card purchaser's information and Gift Card number match the information stored in the database 203. If there is no match, the processor does not activate the Gift Card (operation 405). In one embodiment, the processor can cause a notification sent to the User Client Device 101 to contact the Gift Card Merchant, or a notification to be sent to the Gift Card Merchant client device 102, the Gift Card Merchant server 107 or to the Partner Agent client device 105 detailing the failed attempt to activate the Gift Card.

When the processor determines that there is a match at operation 403 or at operation 407, the processor activates the Gift Card and transmits the authorization and PIN to the requestor's client device at operation 408 and registers the requestor as the Registered Holder. The processor can also transmit information to the Registered Holder regarding the terms and conditions and incentive offer details associated with the Gift Card.

At operation 409, the processor transmits redemption information to the Registered Holder's client device 101. In one embodiment, the processor determines the Business Partners associated with the Gift Card number and provides a list of Business Partners (e.g., dealership locations) where the Registered Holder can redeem the Gift Card. In some embodiments, the processor can also further request redemption details from the Registered Holder's client device 101. The redemption details can include information on the products or services that the Registered Holder wishes to purchase with the Gift Card (e.g., vehicle year, make and model). In one example, when the processor determines that the Gift Card has been redeemed, the processor updates the database by removing the value that was redeemed.

At operation 410, the processor transmits a referral notification to at least one Business Partner client device 105 that includes information on the Registered Holder associated with a Gift Card following activation. The Registered Holder can be the purchaser of the Gift Card or the Gift Card recipient. The information on the Registered Holder can include a first and last name, email address, phone number, address, etc.

At operation 411, the processor transmits information including the Gift Card number and information on the Registered Holder associated with a Gift Card to the Business Partner. The processor can transmit the Registered Holder's information to the Business Partner on a daily basis or instantly. In other embodiments, if the Business Partner (e.g., Volvo) is coordinating the Gift Card redemption with other retailers (e.g., Volvo dealerships, dealership groups, car rental companies, car subscription businesses, service centers, etc.), the processor can transmit information including the Gift Card number and information on the Registered Holder associated with a Gift Card to the other retailers.

FIG. 5 is an exemplary flow diagram of a process 500 to make dynamic changes to the Gift Cards according to one embodiment.

The process 500 starts, at operation 501, the processor of application server 201 in the Gift Card server system 103 receives from a Business Partner agent client device 105 a change request indicating a change in the incentive value that the partner is willing to offer at time of redemption of a Gift Card. The change request can comprise change information including the change in the incentive value, the length of time associated with the change in redemption value, and the products, services or Gift Cards affected by the change (e.g., make and model of car, the year of the car, participating locations for redemption, etc.).

At operation 502, the processor processes the change information and updates the database 203.

At operation 503, the processor determines the Gift Cards that are affected by the change. For example, the processor determines that the change affects a specific make (e.g., Toyota) such that the processor identifies all the gift cards in the database 203 that are associated with the specific make.

At operation 504, the processor transmits a notification to all user client devices 101 associated with the affected Gift Cards. The processor can also transmit the notification to the Gift Card merchant server 107 and Gift Card merchant client device 102. The notification can include the details of the change. The notification can be a push notification or an email or text message. The processor can also cause the notification to be displayed on the user client devices 101.

In some embodiments, the processor can also generate reports to be transmitted or caused to be displayed on a Business Partner agent client device 105. The reports can provide details on Gift Card purchaser information, redemption statistics associated with the Gift Cards, information on the Gift Cards being purchased and redeemed in different geographical markets, information regarding the Gift Card incentive offers from different competitive Business Partners (e.g., OEMs), etc.

The system can also use post Gift Card redemption surveys to verify customer satisfaction that can be shared with the Gift Card merchant, the Gift Card business partner, and the Gift Card server system for further processing. In one embodiment, after the gift card is redeemed, the Gift Card purchaser or Registered Holder that redeemed the gift card is provided with the redemption survey. In one embodiment, the Gift Card server system 103 transmits the redemption survey to the Gift Card purchaser or Registered Holder's user client device 101 to be displayed. In one embodiment, the Gift Card purchaser or Registered Holder's user client device 101 transmits the results of the survey back to the Gift Card server system 103. The Gift Card server system 103 can process the results to generate the reports. The Gift Card server system 103 can also relay the results to the Gift Card merchant or the Gift Card business partner.

In some embodiments, the processor of the application server 201 in the Gift Card server system 103 can receive the change request from a client device associated with the store (e.g., Volvo Dealership) at which the gift card is redeemable. In this embodiment, the store (e.g., Volvo Dealership) is also able to make dynamic updates to the gift cards.

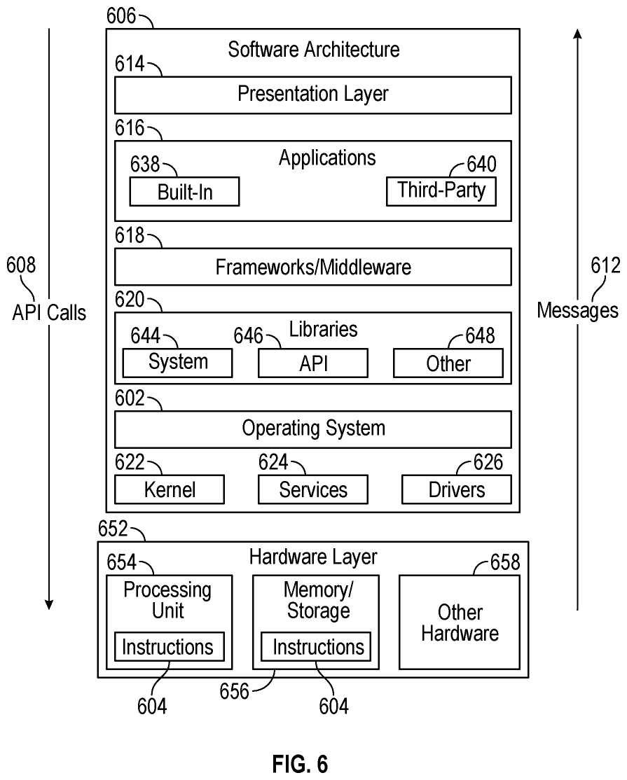

FIG. 6 is a block diagram illustrating an example software architecture 606, which may be used in conjunction with various hardware architectures herein described. FIG. 6 is a non-limiting example of a software architecture and it will be appreciated that many other architectures may be implemented to facilitate the functionality described herein. The software architecture 606 may execute on hardware such as machine 700 of FIG. 7 that includes, among other things, processors 704, memory 714, and I/O components 718. A representative hardware layer 652 is illustrated and can represent, for example, the machine 700 of FIG. 7. The representative hardware layer 652 includes a processing unit 654 having associated executable instructions 604. Executable instructions 604 represent the executable instructions of the software architecture 606, including implementation of the methods, components and so forth described herein. The hardware layer 652 also includes memory and/or storage modules memory/storage 656, which also have executable instructions 604. The hardware layer 652 may also comprise other hardware 658.

As used herein, the term “component” may refer to a device, physical entity, or logic having boundaries defined by function or subroutine calls, branch points, application program interfaces (APIs), and/or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions.

Components may constitute either software components (e.g., code embodied on a machine-readable medium) or hardware components. A “hardware component” is a tangible unit capable of performing certain operations and may be configured or arranged in a certain physical manner. In various exemplary embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or in any suitable combination thereof. For example, a hardware component may include dedicated circuitry or logic that is permanently configured to perform certain operations.

A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations.

A processor may be, or include, any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. In considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access.

For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, the operations of a method may be performed by one or more processors or processor-implemented components.

Moreover, the one or more processors may also operate to support performance of the relevant operations in a “cloud computing” environment or as a “software as a service” (SaaS). For example, the operations may be performed by a group of computers (as examples of machines including processors), with these operations being accessible via a network (e.g., the Internet) and via one or more appropriate interfaces (e.g., an Application Program Interface (API)). The performance of the operations may be distributed among the processors, not only residing within a single machine, but deployed across a number of machines. In some exemplary embodiments, the processors or processor-implemented components may be located in a single geographic location (e.g., within a home environment, an office environment, or a server farm). In other exemplary embodiments, the processors or processor-implemented components may be distributed across a number of geographic locations (e.g. at several different partnership businesses, a server farm, and a mobile device).

In the exemplary architecture of FIG. 6, the software architecture 606 may be conceptualized as a stack of layers where each layer provides particular functionality. For example, the software architecture 606 may include layers such as an operating system 602, libraries 620, applications 616, and a presentation layer 614. Operationally, the applications 616 and/or other components within the layers may invoke application programming interface (API) API calls 608 through the software stack and receive messages 612 in response to the API calls 608. The layers illustrated are representative in nature and not all software architectures have all layers. For example, some mobile or special purpose operating systems may not provide a frameworks/middleware 618, while others may provide such a layer. Other software architectures may include additional or different layers.

The operating system 602 may manage hardware resources and provide common services. The operating system 602 may include, for example, a kernel 622, services 624, and drivers 626. The kernel 622 may act as an abstraction layer between the hardware and the other software layers. For example, the kernel 622 may be responsible for memory management, processor management (e.g., scheduling), component management, networking, security settings, and so on. The services 624 may provide other common services for the other software layers. The drivers 626 are responsible for controlling or interfacing with the underlying hardware. For instance, the drivers 626 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 620 provide a common infrastructure that is used by the applications 616 and/or other components and/or layers. The libraries 620 provide functionality that allows other software components to perform tasks in an easier fashion than to interface directly with the underlying operating system 602 functionality (e.g., kernel 622, services 624 and/or drivers 626). The libraries 620 may include system libraries 644 (e.g., C standard library) that may provide functions such as memory allocation functions, string manipulation functions, mathematical functions, and the like. In addition, the libraries 620 may include API libraries 646, such as media libraries, (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 620 may also include a wide variety of other libraries 648 to provide many other APIs to the applications 616 and other software components/modules.

The frameworks/middleware 618 (also sometimes referred to as middleware) provide a higher-level common infrastructure that may be used by the applications 616 and/or other software components/modules. For example, the frameworks/middleware 618 may provide various graphic user interface (GUI) functions, high-level resource management, high-level location services, and so forth. The frameworks/middleware 618 may provide a broad spectrum of other APIs that may be utilized by the applications 616 and/or other software components/modules, some of which may be specific to a particular operating system 602 or platform.

The applications 616 include built-in applications 638 and/or third-party applications 640. Examples of representative built-in applications 638 may include, but are not limited to, a contacts application, a browser application, a book reader application, a location application, a media application, a messaging application, and/or a game application. The third-party applications 640 may invoke the API calls 608 provided by the mobile operating system (such as operating system 602) to facilitate functionality described herein.

The applications 616 may use built in operating system functions (e.g., kernel 622, services 624 and/or drivers 626), libraries 620, and frameworks/middleware 618 to create user interfaces to interact with users of the system. Alternatively, or additionally, in some systems interactions with a user may occur through a presentation layer, such as presentation layer 614. In these systems, the application/component “logic” can be separated from the aspects of the application/component that interact with a user.

FIG. 7 is a block diagram illustrating components (also referred to herein as “modules”) of a machine 700, according to some exemplary embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 710 (e.g., software, a program, an application, an applet, an app, or other executable code) for causing the machine 700 to perform any one or more of the methodologies discussed herein may be executed. As such, the instructions 710 may be used to implement modules or components described herein. The instructions 710 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 710, sequentially or otherwise, that specify actions to be taken by machine 700. Further, while only a single machine 700 is illustrated, the term “machine” shall also be taken to include a collection of machines that individually or jointly execute the instructions 710 to perform any one or more of the methodologies discussed herein.

The machine 700 may include processors 704, memory memory/storage 706, and I/O components 718, which may be configured to communicate with each other such as via a bus 702. The memory/storage 706 may include a memory 714, such as a main memory, or other memory storage, and a storage unit 716, both accessible to the processors 704 such as via the bus 702. The storage unit 716 and memory 714 store the instructions 710 embodying any one or more of the methodologies or functions described herein. The instructions 710 may also reside, completely or partially, within the memory 714, within the storage unit 716, within at least one of the processors 704 (e.g., within the processor's cache memory), or any suitable combination thereof, during execution thereof by the machine 700. Accordingly, the memory 714, the storage unit 716, and the memory of processors 704 are examples of machine-readable media.

As used herein, the term “machine-readable medium,” “computer-readable medium,” “non-transitory computer-readable medium” or the like may refer to any component, device or other tangible media able to store instructions and data temporarily or permanently. Examples of such media may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” may also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” may refer to a single storage apparatus or device, as well as “cloud-based” storage systems or storage networks that include multiple storage apparatus or devices. The term “machine-readable medium” excludes signals per se.

The I/O components 718 may include a wide variety of components to provide a user interface for receiving input, providing output, producing output, transmitting information, exchanging information, capturing measurements, and so on. The specific I/O components 718 that are included in the user interface of a particular machine 700 will depend on the type of machine. For example, portable machines such as mobile phones will likely include a touch input device or other such input mechanisms, while a headless server machine will likely not include such a touch input device. It will be appreciated that the I/O components 718 may include many other components that are not shown in FIG. 7. The I/O components 718 are grouped according to functionality merely for simplifying the following discussion and the grouping is in no way limiting. In various exemplary embodiments, the I/O components 718 may include output components 726 and input components 728. The output components 726 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 728 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like. The input components 728 may also include one or more image-capturing devices, such as a digital camera for generating digital images and/or video.

In further exemplary embodiments, the I/O components 718 may include biometric components 730, motion components 734, environmental environment components 736, or position components 738, as well as a wide array of other components. One or more of such components (or portions thereof) may collectively be referred to herein as a “sensor component” or “sensor” for collecting various data related to the machine 700, the environment of the machine 700, a user of the machine 700, or a combination thereof.

For example, the biometric components 730 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 734 may include acceleration sensor components (e.g., accelerometer), gravitation sensor components, rotation sensor components (e.g., gyroscope), and so forth. The environment components 736 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 738 may include location sensor components (e.g., a Global Position system (GPS) receiver component), altitude sensor components (e.g., altimeters or barometers that detect air pressure from which altitude may be derived), orientation sensor components (e.g., magnetometers), and the like. For example, the location sensor component may provide location information associated with the machine 700, such as the machine's 700 GPS coordinates and/or information regarding a location the machine 700 is at currently (e.g., the name of a restaurant or other business).

Communication may be implemented using a wide variety of technologies. The I/O components 718 may include communication components 740 operable to couple the machine 700 to a network 732 or devices 720 via coupling 722 and coupling 724 respectively. For example, the communication components 740 may include a network interface component or other suitable device to interface with the network 732. In further examples, communication components 740 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 720 may be another machine or any of a wide variety of peripheral devices (e.g., a peripheral device coupled via a Universal Serial Bus (USB)).

Moreover, the communication components 740 may detect identifiers or include components operable to detect identifiers. For example, the communication components 740 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740, such as, location via Internet Protocol (IP) geo-location, location via Wi-Fi® signal triangulation, location via detecting an NFC beacon signal that may indicate a particular location, and so forth.

Where a phrase similar to “at least one of A, B, or C,” “at least one of A, B, and C,” “one or more A, B, or C,” or “one or more of A, B, and C” is used, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Changes and modifications may be made to the disclosed embodiments without departing from the scope of the present disclosure. These and other changes or modifications are intended to be included within the scope of the present disclosure, as expressed in the following claims.

What is claimed is:

1. A server system comprising:
a processor; and
a memory to store instructions, when executed by the processor, causes the processor to:
receiving from a partner agent client device a change request, the change request comprising item information, a change in a value, and a length of time;
updating a database based on the change request;
determining a Gift Card based on the change request; and
transmits a notification to a user client device associated with the gift card, the notification including the change request.

2. The server system of claim 1, further comprising:
receiving an initial data, wherein the initial data comprises an initial prepaid value and an initial redemption value, and
storing the initial data in the database.

3. The server system of claim 2, wherein updating the database comprises:
updating the initial redemption value with a promotional redemption value based on the change in the value from the partner agent client device, and
associating the promotional redemption value with the length of time from the partner agent client device.

4. The server system of claim 3, wherein the promotional redemption value is greater than the initial redemption value, and the length of time is a promotional period.

5. The server system of claim 4, further comprising:
determining that the promotional period is expired; and
updating the database by replacing the promotional redemption value with the initial redemption value.

6. The server system of claim 5, further comprising:
determining that the gift card has been redeemed; and
updating the database by removing the value redeemed.

7. The server system of claim 6, further comprising:
receiving from the partner agent client device the change request, the change request comprising post redemption survey and any associated promotional information;
updating database based on the change request; and
transmits a notification to a user client device associated with the gift card, the notification including the change request.

8. A method comprising:
receiving, by a processor, from a partner agent client device a change request, the change request comprising item information, a change in a value, and a length of time;
updating a database based on the change request;
determining a Gift Card based on the change request; and
transmits a notification to a user client device associated with the gift card, the notification including the change request.

9. The method of claim 8, further comprising:
receiving an initial data, wherein the initial data comprises an initial prepaid value and an initial redemption value, and
storing the initial data in the database.

10. The method of claim 9, wherein updating the database comprises:
updating the initial redemption value with a promotional redemption value based on the change in the value from the partner agent client device, and
associating the promotional redemption value with the length of time from the partner agent client device.

11. The method of claim 10, wherein the promotional redemption value is greater than the initial redemption value, and the length of time is a promotional period.

12. The method of claim 11, further comprising:
determining that the promotional period is expired; and
updating the database by replacing the promotional redemption value with the initial redemption value.

13. The method of claim 12, further comprising:
determining that the gift card has been redeemed; and
updating the database by removing the value redeemed.

14. The method of claim 13, further comprising:
receiving from the partner agent client device the change request, the change request comprising post redemption survey and any associated promotional information;
updating database based on the change request; and
transmits a notification to a user client device associated with the gift card, the notification including the change request.

15. A non-transitory computer-readable medium having stored thereon instructions, when executed by a processor, causes a processor to perform operations comprising:
receiving from a partner agent client device a change request, the change request comprising item information, a change in a value, and a length of time;
updating a database based on the change request;
determining a Gift Card based on the change request; and
transmits a notification to a user client device associated with the gift card, the notification including the change request.

16. The non-transitory computer-readable medium of claim 15, wherein the processor to perform operations further comprising:
receiving an initial data, wherein the initial data comprises an initial prepaid value and an initial redemption value, and
storing the initial data in the database.

17. The non-transitory computer-readable medium of claim 16, wherein updating the database comprises:
updating the initial redemption value with a promotional redemption value based on the change in the value from the partner agent client device, and
associating the promotional redemption value with the length of time from the partner agent client device.

18. The non-transitory computer-readable medium of claim 17, wherein the promotional redemption value is greater than the initial redemption value, and the length of time is a promotional period.

19. The non-transitory computer-readable medium of claim 18, wherein the processor to perform operations further comprising:
determining that the promotional period is expired; and
updating the database by replacing the promotional redemption value with the initial redemption value.

20. The non-transitory computer-readable medium of claim 19, wherein the processor to perform operations further comprising:
determining that the gift card has been redeemed;
updating the database by removing the value redeemed;
receiving from the partner agent client device the change request, the change request comprising post redemption survey and any associated promotional information;
updating database based on the change request; and
transmits a notification to a user client device associated with the gift card, the notification including the change request.
